(19) United States
(12) Patent Application Publication
(10) Pub. No.: US 2006/0011537 A1
(43) Pub. Date: Jan. 19, 2006

(54) Septic tank free from dung-sucking operation

(76) Inventor: Ching-Gin Tsang, Pan-Chiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/155,639

(22) Filed: Jun. 20, 2005

(30) Foreign Application Priority Data
Jul. 15, 2004 (TW) 093211189

(51) Int. Cl. B01D 21/02

(52) U.S. Cl. 210/532.2

(57) ABSTRACT

A septic tank free from dung-sucking operation comprises a septic tank has an inlet and an outlet and further has a funnel-shaped tapered bottom inside the septic tank. The tapered bottom has a conicity. The septic tank further includes an internal discharge pipe with a small diameter. A lower end of the discharge pipe is spaced from a bottommost section of the tapered bottom by a small gap. An upper end of the discharge pipe is connected with the outlet of the septic tank. By means of the tapered bottom of the septic tank, the decomposed and precipitated excreta are collected in the bottommost section of the septic tank. Due to the small gap between the intake end of the discharge pipe and the bottommost section of the tapered bottom and the fine diameter of the discharge pipe, the excreta can be easily taken into the discharge pipe.

### BACKGROUND OF THE INVENTION

1. Field of the Invention

The present invention is related to a septic tank having a funnel-shaped tapered bottom inside the septic tank. The septic tank further includes an internal discharge pipe with a small diameter. A lower end of the discharge pipe is an intake end adjacent to and spaced from a bottommost section of the tapered bottom by a small gap. The excreta entering the septic tank can be easily siphoned into the discharge pipe and discharged out from an outlet without solidifying and tarrying on the bottom of the septic tank. Therefore, it is unnecessary to periodically suck the excreta out of the septic tank by external force.

2. Description of the Prior Art

FIG. 1 shows an existent septic tank having two to four tank bodies communicating with each other. An upper end of the corroding tank 11 is connected to a toilet 13 via an excreta-discharging pipe 12. The excreta are discharged into the tank 11 where the solid materials are precipitated and decomposed by anaerobes. After processed, the dirty water infiltrates into the next filtering tank 14 for filtering off the impurities. Then the dirty water flows into the oxidizing tank 15 where the organic matters entrained by the water are decomposed by aerobes into water suitable for discharge. Finally, the water flows into the draining tank 16 to be discharged from an outlet thereof into a gutter or a sewer.

By means of the above septic tank as shown in FIG. 1, through the procedures of precipitation, corrosion, filtering and oxidization, the excreta are processed into wastewater up to the discharge standard. However, the solid excreta have accumulated in the corroding tank for a long time. Therefore, after a period of use, it is necessary to use a dung-cart to suck out the excreta for keeping normal function of the corroding tank. Currently, anaerobes and aerobes are added into the septic tank to reduce the accumulating excreta and odors. However, such measure can simply prolong the period between regular sucking of the excreta, while failing to avoid accumulation of the excreta. Therefore, only the odors are reduced. The shortcoming of the above conventional septic tank is that the septic tank has a plane bottom so that the solid materials precipitating onto the bottom can be hardly entrained by dirty water to the final discharge pipe. Therefore, it is tried by the applicant to provide a measure for preventing the solid materials from tarrying in the corroding tank 11 of the septic tank.

### SUMMARY OF THE INVENTION

It is therefore a primary object of the present invention to provide a septic tank free from dung-sucking operation. The septic tank has a funnel-shaped tapered bottom inside the septic tank. The tapered bottom has a conicity not larger than 90 degrees. Accordingly, a slope is formed on the bottom of the septic tank, whereby the corroded and precipitated excreta can easily quickly roll or slide to the bottommost section of the septic tank. The septic tank further includes an internal discharge pipe with a small diameter within 6˜8 cm. A lower intake end of the discharge pipe is adjacent to and spaced from a bottommost section of the tapered bottom by a small gap. By means of the small gap and the fine diameter of the discharge pipe, the corroded excreta flowing to the tapered bottom can be easily taken into the discharge pipe and further decomposed and oxidized therein. When the accumulating materials in the discharge pipe reach the height of the discharge end of the discharge pipe, the materials will spill out of the outlet of the tank into a sewer.

By means of the tapered bottom of the septic tank, the decomposed and precipitated excreta will quickly move to the bottom and gather in the bottommost section of the septic tank. The intake end of the discharge pipe is adjacent to the bottommost section so that the excreta and liquid successively entering the septic tank can further push the excreta into the discharge pipe. In addition, in condition that the excreta can be successfully discharged, the diameter of the discharge pipe is narrowed. Therefore, the excreta entering the septic tank can be easily siphoned into the discharge pipe and discharged out from an outlet without solidifying and tarrying on the bottom of the septic tank. Therefore, it is unnecessary to periodically suck the excreta out of the septic tank. In addition, the septic tank has one single tank body to save space.

The present invention can be best understood through the following description and accompanying drawings wherein:

### BRIEF DESCRIPTION OF THE DRAWINGS

FIG. 1 is a sectional view of a conventional septic tank;

FIG. 2 is a sectional view of the septic tank of the present invention;

FIG. 3 is a top view of an embodiment of the present invention, in which the septic tank is a cylindrical tank;

FIG. 4 is a top view of another embodiment of the present invention, in which the septic tank is a rectangular parallelepiped tank;

FIG. 5 is an enlarged view of a part of the septic tank of FIG. 2; and

FIG. 6 is a sectional view of the septic tank of the present invention, in which a filtering screen is additionally mounted in the tank body.

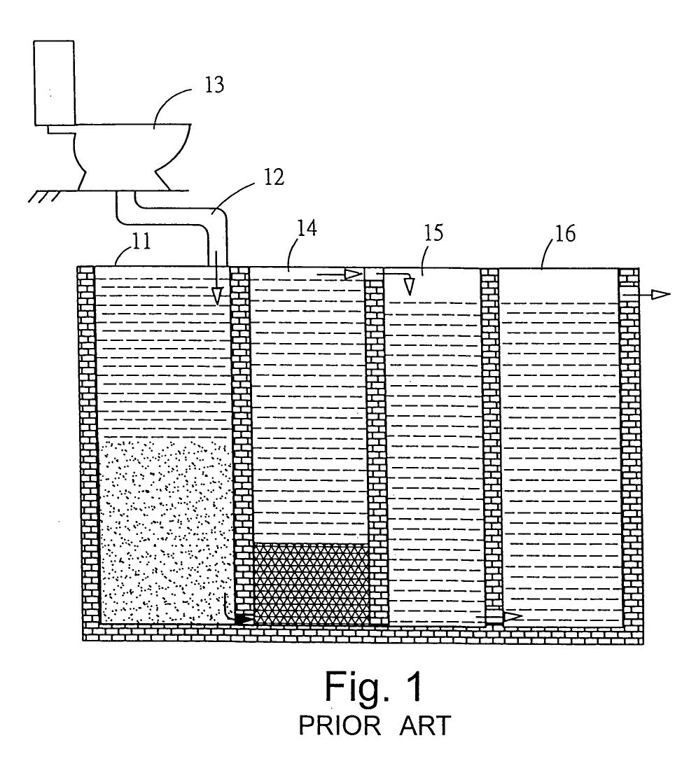

### DETAILED DESCRIPTION OF THE PREFERRED EMBODIMENTS

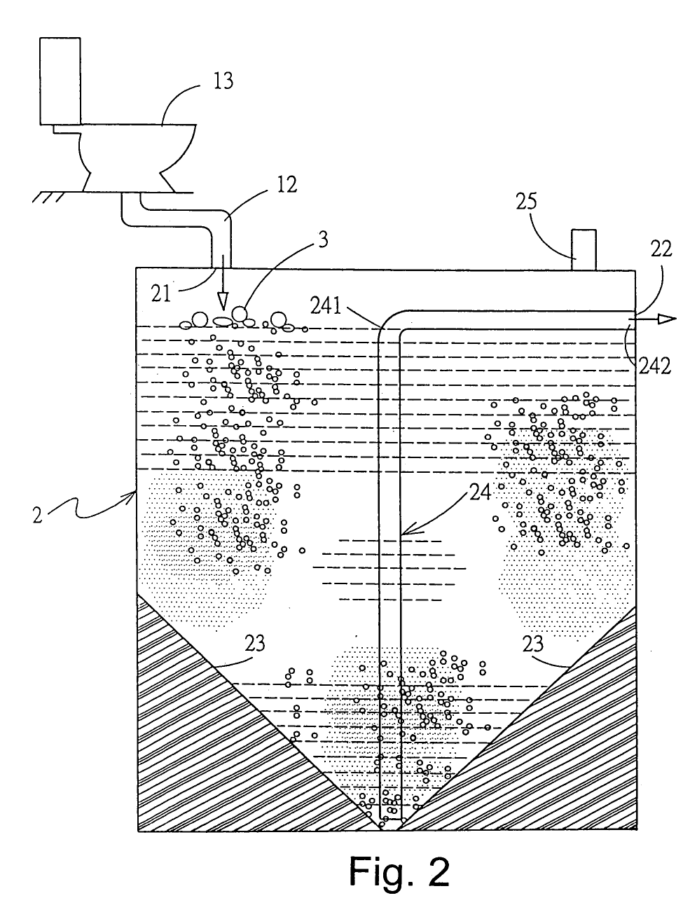

Please refer to FIG. 2. The septic tank 2 of the present invention has an inlet 21 and an outlet 22. The inlet 21 is connected with the excreta-discharging pipe 12 for conducting the excreta from the toilet 13 into the tank. The septic tank 2 has a funnel-shaped tapered bottom 23. The tapered bottom 23 is inclined downward toward the center of the septic tank 2. A discharge pipe 24 is arranged in the septic tank 2. The discharge pipe 24 has a vertical section, a horizontal section and a bight section 241 integrally interconnected between the vertical and horizontal sections. The vertical section of the discharge pipe 24 vertically upward extends from the bottommost section of the tapered bottom 23 to the bight section 241. The horizontal section horizontally extends from the bight section 241 to the outlet 22 of the septic tank 2. A discharge end 242 of the discharge pipe 24 is connected with the outlet 22 of the septic tank 2.

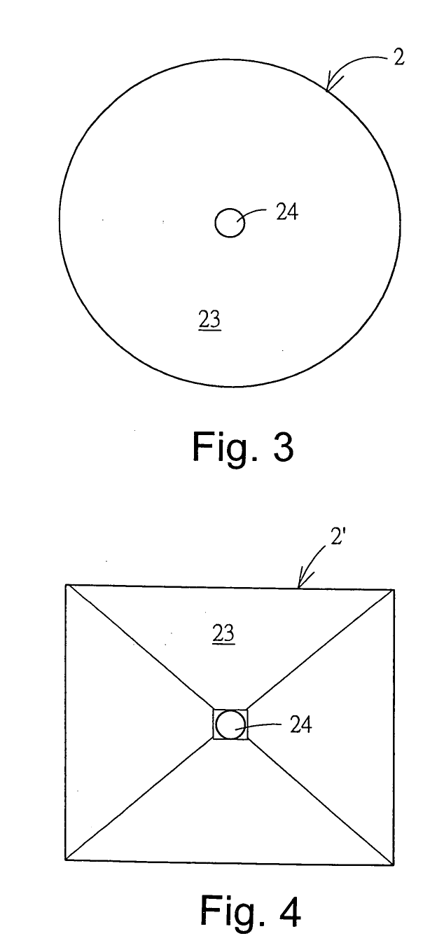

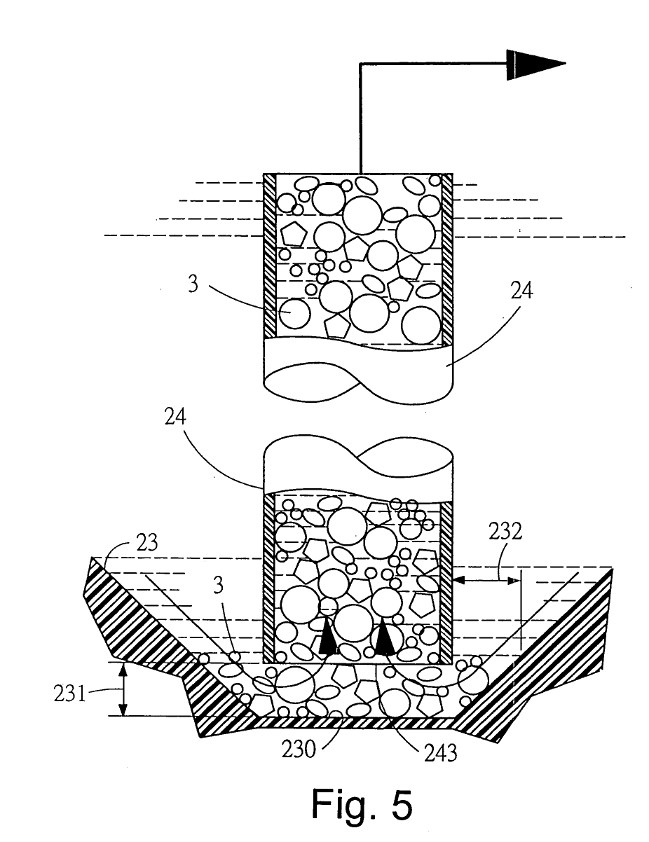

FIGS. 3 and 4 are top views of the septic tank of the present invention. The septic tank can be a cylindrical tank 2 as shown in FIG. 3 or a rectangular parallelepiped tank 2′ as shown in FIG. 4. Alternatively, the septic tank can have any other shape adapted to the configuration of the working site. The discharge pipe 24 can be positioned at the center of the septic tank 2 or any other position as necessary. A lower end of the discharge pipe 24 is an intake end 243. As shown in FIG. 5, the intake end 243 is spaced from the bottommost section 230 of the tapered bottom 23 by a gap 231. The outer circumference of the intake end 243 is spaced from the sidewall of the tapered bottom 23 by a gap 232. The gaps 231, 232 serve as narrow paths for speeding the flow of the excreta. The gaps 231, 232 should not be too large to lose their function. However, the gaps 231, 232 also should not be too narrow to jam the excreta. The optimal width of the gaps 231, 232 is within 2˜4 cm.

Referring to FIGS. 2 and 5, in normal state, water is fully reserved in the septic tank 2. The water level is flush with the discharge end 242. In order to make the excreta quickly move from the tapered bottom 23 to the intake end 243 of the discharge pipe 24, the conicity of the tapered bottom preferably should not exceed 90 degrees. The conicity is preferably within 50˜60 degrees. Accordingly, after the excreta 3 entering the septic tank 2 are corroded and precipitated, the excreta 3 will not accumulate in the tank. Instead, the excreta 3 will quickly move along the tapered bottom 23 to a position under the intake end 243 of the discharge pipe 24. When squeezed by the successive precipitants, the excreta 3 will get into the discharge pipe 24. The discharge pipe 24 has a diameter within 6˜8 cm. By means of the balance of the liquid pressures inside and outside the discharge pipe 24, the excreta 3 entering the discharge pipe 24 are sucked without downward dropping. Therefore, the excreta 3 can be further corroded, filtered and oxidized in the discharge pipe 24. When the accumulating materials in the discharge pipe 24 ascend and reach the height of the discharge end 242, the processed liquid will automatically spill out of the outlet 22 of the tank into the sewer.

In order to enhance the purifying capability of the septic tank 2, a bactericidal unit such as ultraviolet optic contact enzyme can be arranged at the outlet 22. In addition, in the embodiment of FIG. 2, the excreta-discharging pipe 12 goes into the tank body from the top thereof. According to such arrangement, the marsh gas in the tank may flow through the excreta-discharging pipe 12 and the toilet 13 back into the room. This will lead to stink. Therefore, a ventiduct 25 can be arranged on upper side of the septic tank 2 for exhausting the tank. Alternatively, the excreta-discharging pipe 12 can be arranged on a lateral side of the tank body.

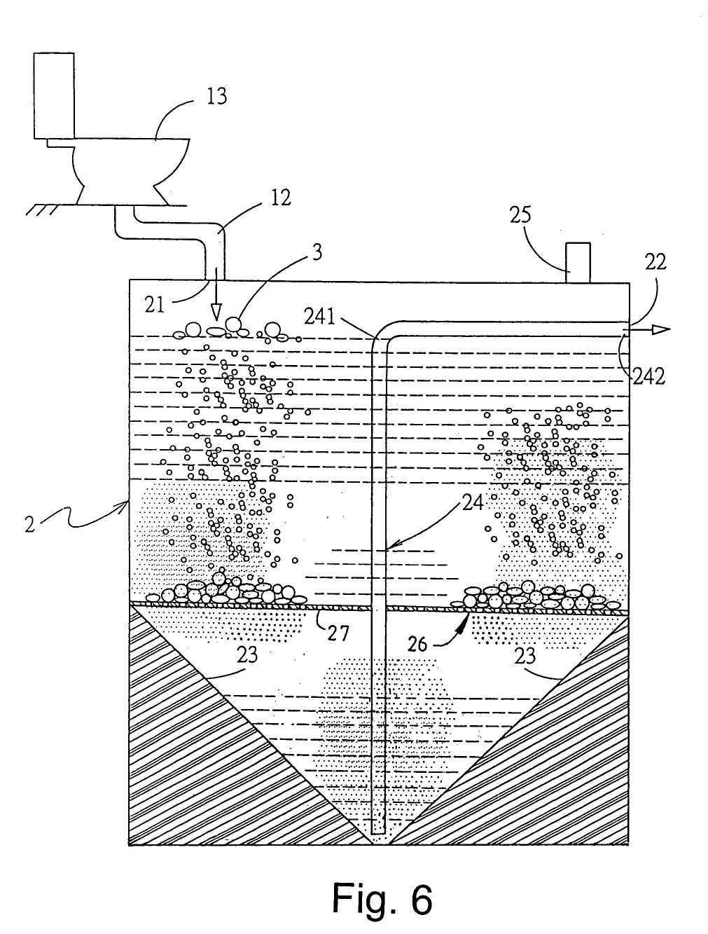

Referring to FIG. 6, a filtering screen 26 can be additionally mounted in the septic tank 2. Numerous screen orifices 27 are distributed over the filtering screen 26. The diameter of the screen orifices 27 is relatively small for keeping the not corroded excreta on upper side of the filtering screen 26. Only the corroded excreta can pass through the screen orifices 27 of the filtering screen 26 and drop to the bottom of the septic tank 2. The not yet corroded excreta remaining on the upper side of the filtering screen 26 are further corroded and decomposed up to the excreta discharge standard regulated by environment protection authority. Then with the flush, the excreta are flushed to the bottom of the septic tank 2. The corroded excreta then are taken into the discharge pipe 24. Finally, when the corroded excreta accumulating in the discharge pipe 24 reach the discharge height, the excreta are discharged from the outlet 22 of the septic tank 2 into the sewer.

The above embodiments are only used to illustrate the present invention, not intended to limit the scope thereof. Many modifications of the above embodiments can be made without departing from the spirit of the present invention.

What is claimed is:

1. A septic tank free from dung-sucking operation, the septic tank having an inlet and an outlet, the septic tank further having a funnel-shaped tapered bottom inside the septic tank, the tapered bottom having a conicity not larger than 90 degrees, the septic tank further comprising a discharge pipe arranged inside the septic tank, the discharge pipe having a small diameter, a lower end of the discharge pipe being an intake end spaced from a bottommost section of the tapered bottom by a gap, an outer circumference of the intake end being spaced from a sidewall of the tapered bottom by another gap, an upper end of the discharge pipe being a discharge end connected with the outlet of the septic tank.

2. The septic tank free from dung-sucking operation as claimed in claim 1, wherein the conicity of the tapered bottom is within 50 to 60 degrees.

3. The septic tank free from dung-sucking operation as claimed in claim 1, wherein the gaps between the intake end of the discharge pipe and the bottommost section and the sidewall of the tapered bottom are within 2˜4 cm.

4. The septic tank free from dung-sucking operation as claimed in claim 1, wherein the discharge pipe has a diameter within 6 to 8 cm.

5. The septic tank free from dung-sucking operation as claimed in claim 1, wherein the septic tank is a cylindrical tank.

6. The septic tank free from dung-sucking operation as claimed in claim 1, wherein the septic tank is a rectangular parallelepiped tank.

7. The septic tank free from dung-sucking operation as claimed in claim 1, wherein the septic tank has any shape.

8. The septic tank free from dung-sucking operation as claimed in claim 1, wherein a bactericidal unit is arranged at the discharge end of the discharge pipe.

9. The septic tank free from dung-sucking operation as claimed in claim 1, further comprising a filtering screen mounted in the septic tank, numerous screen orifices being distributed over the filtering screen, the filtering screen serving to keep not yet corroded excreta on upper side of the filtering screen and permit only the corroded excreta to pass through the screen orifices and drop to the bottom of the septic tank.
